(19) United States
(12) Patent Application Publication
(10) Pub. No.: US 2007/0022261 A1
(43) Pub. Date: Jan. 25, 2007

(54) Method of interleaving asymmetric memory arrays

(75) Inventor: Bruce Young, Le Mars, IA (US)

Correspondence Address: GATEWAY, INC.;ATTN: Patent Attorney, 610 GATEWAY DRIVE, MAIL DROP Y-04, N. SIOUX CITY, SD, 57049, US

(73) Assignee: Gateway Inc.

(21) Appl. No.: 11/184,704

(22) Filed: Jul. 19, 2005

(51) Int. Cl. G06F 13/28

(52) U.S. Cl. 711/157

(57) ABSTRACT

A method of interleaving asymmetric memory arrays for providing more uniform memory access performance in computer systems utilizing asymmetrical memory configurations. The method of interleaving asymmetric memory arrays includes grouping a quantity of memory devices into a paired set and one unpaired device if the quantity of memory devices present is an odd number; interleaving the paired set of memory devices to form an initially interleaved set; and interleaving the unpaired device with the initially interleaved set to form a finally interleaved set of memory devices if the quantity of memory devices present is an odd number.

### BACKGROUND OF THE INVENTION

1. Field of the Invention

The present invention relates to interleaving techniques and more particularly pertains to a new method of interleaving asymmetric memory arrays for providing more uniform memory access performance in computer systems utilizing asymmetrical memory configurations.

2. Description of the Prior Art

Interleaving refers to any number of techniques for distributing consecutive block addresses over separate memory banks, through various types of virtual addressing, to diminish the effects of the latency times associated with sequential read or write operations to a single physical memory device. As processing speeds increase, and the physical size of files being processed or manipulated increases, minimizing this type of latency becomes more determinative of system performance.

In addition to minimizing the effects of latency times to enhance system performance, the uniformity of each of these memory operations is also an important contributor to overall system performance.

Conventionally, interleaving schemes required that memory devices be configured for interleaving in powers of two. That is, the methods of interleaving worked for two, four, eight, sixteen, or thirty-two memory devices. If, however, the quantity of memory devices in a system was not a power of two, such as three, six, or ten, the devices in excess of the next lowest power of two were not interleaved. This practice introduced two distinct classes of memory, interleaved and non-interleaved, within the same system with significantly different performance based upon the specific memory actually used by any particular file.

U.S. Pat. No. 5, 341,486 to Castle, entitled “Automatically Variable Memory Interleaving System”, presents one such interleaving system. The system described by Castle accommodates non-power-of-two configurations by breaking the memory devices into multiple power-of-two groups and then interleaving each group separately. As an example if six memory devices were utilized, a first group of four devices would be interleaved, and a second group of two devices would be interleaved.

Additionally, the system described by Castle addresses odd number configurations by forming at least one even numbered group of memory devices and one remaining memory device. The remaining memory device is not interleaved. As an example, if seven memory devices were to be used a first group of four devices would be interleaved, and a second group of two devices would be interleaved, and the remaining device would remain non-interleaved.

More recently, attempts have been made to improve the potential for interleaving by allowing the interleaving of even, but non-power-of-two, number of physical devices.

U.S. Pat. No. 6,233, 662 to Prince, entitled “Method and Apparatus For Interleaving Memory Across Computer Memory Banks”, describes an interleaving tool for interleaving memory in non-power-of two configurations. As an example, if six memory devices are to be interleaved, the interleaving tool would split the memory space into six equal portions that are interleaved over four banks (four being six rounded down to the nearest power of two).

Similarly, U.S. Pat. No. 6,381,668 to Lunteren, entitled “Address Mapping for System Memory”, also provides a system for interleaving non-power-of-two memory blocks by utilizing a look-up table and variable strides.

As will be readily appreciated by those skilled in the art, a wide array of interleaving techniques is available. Illustrative examples include sequential, multi-cache line interleaving (MCI), cache effect interleaving (CEI), and DRAM Page interleaving (DPI) among others. Each of these various techniques has their own optimal applicability depending upon the type of operation and the class of memory used. However, the known interleaving techniques are limited in that these techniques do not interleave all of the memory devices present if an odd number of devices are present or in some cases if the number of devices present is not a power of two (such that the “excess” devices over the next lower power of two are also not interleaved). This lack of uniformity can result in degraded system performance.

### SUMMARY OF THE INVENTION

The present invention enhances overall system performance by improving the uniformity of memory operation by providing interleaving of all memory devices, even when an odd number of devices are present.

To attain this, the present invention may be implemented as a method involving determining a quantity of memory devices present to be interleaved, and if the quantity of memory devices present is an odd number, grouping the quantity of memory devices into a paired set and one unpaired device, interleaving the paired set of memory devices to form an initially interleaved set, and interleaving the unpaired device with the initially interleaved set to form a finally interleaved set of memory devices.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

Those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

One significant advantage of the present invention is the increased uniformity of memory transactions across all of the memory devices regardless of the particular number of devices, to thereby improve overall system performance.

Further advantages of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a schematic diagram of a hardware system suitable for the implementation of the new method of interleaving asymmetric memory arrays according to the present invention.

FIG. 2 is a schematic conceptual block diagram of an illustrative interleaved main memory comprising three memory devices in accordance with the present invention.

FIG. 3 is a schematic flow chart of the present invention.

FIG. 4 is a schematic conceptual block diagram of another illustrative interleaved main memory comprising seven memory devices in accordance with the present invention.

### DESCRIPTION OF PREFERRED EMBODIMENTS

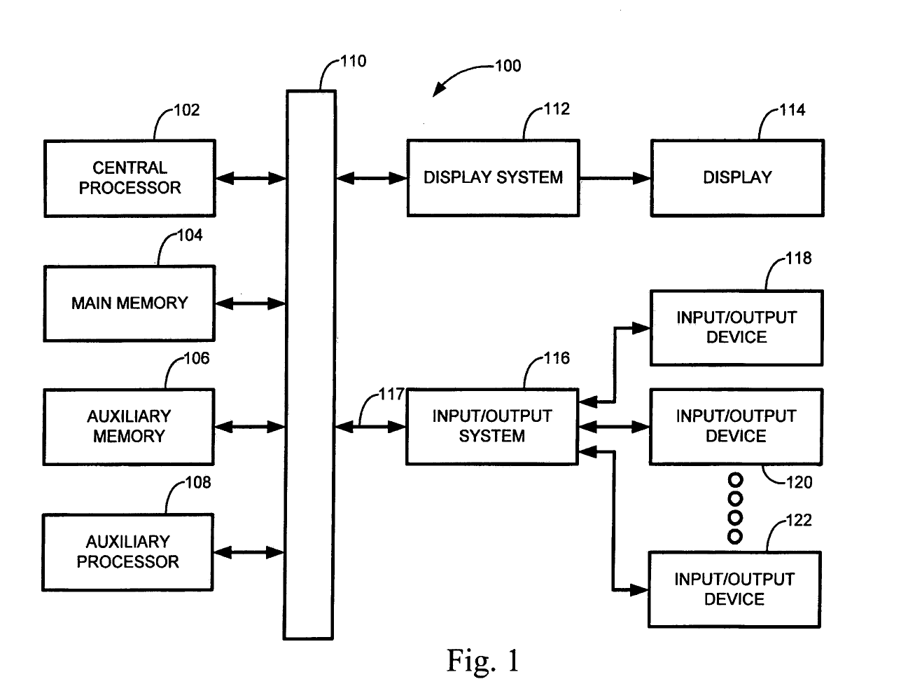

With reference now to the drawings, and in particular to FIGS. 1 through 4 thereof, a new method of interleaving asymmetric memory arrays embodying the principles and concepts of the present invention and generally designated by the reference numeral 10 will be described.

Reference will now be made in detail to the presently preferred embodiment of the invention, an example of which is illustrated in the accompanying drawings.

Referring now to FIG. 1, a hardware system suitable for the application of the memory interleaving technique of the present invention is shown. The hardware system shown in FIG. 1 is generally representative of the hardware architecture of an information handling system 100. A central processor 102 controls the information handling system 100. Central processor 102 includes a central processing unit such as a microprocessor or microcontroller for executing programs, performing data manipulations and controlling the tasks of information handling system 100. Communication with central processor 102 is implemented through a system bus 110 for transferring information among the components of information handling system 100. Bus 110 may include a data channel for facilitating information transfer between storage and other peripheral components of information handling system 100. Bus 110 further provides the set of signals required for communication with central processor 102 including a data bus, address bus, and control bus. Bus 110 may comprise any state of the art bus architecture according to promulgated standards, for example industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and so on. Furthermore, a peripheral bus 117 may be coupled with bus 110 and may be compliant with any promulgated industry standard. For example, bus 117 may be designed in compliance with any of the following bus architectures: Industry Standard Architecture (ISA), Extended Industry Standard Architecture (EISA), Micro Channel Architecture, Peripheral Component Interconnect (PCI), Universal Serial Bus (USB), Access bus, IEEE P1394, Apple Desktop Bus (ADB), Concentration Highway Interface (CHI), Fire Wire, Geo Port, or Small Computer Systems Interface (SCSI), for example.

Other components of information handling system 100 include main memory 104, auxiliary memory 106, and an auxiliary processor 108 as required. Main memory 104 provides storage of instructions and data for programs executing on central processor 102. Main memory 104 is typically semiconductor based memory such as dynamic random access memory (DRAM) or static random access memory (SRAM). Auxiliary memory 106 provides storage of instructions and data that are loaded into the main memory 104 before execution. Auxiliary memory 106 may include semiconductor based memory such as read-only memory (ROM), programmable read-only memory (PROM) erasable programmable read-only memory (EPROM), electrically erasable read-only memory (EEPROM), or flash memory (block oriented memory similar to EEPROM). Auxiliary memory 106 may also include a variety of non-semiconductor based memories, including but not limited to magnetic tape, drum, floppy disk, hard disk, optical, laser disk, compact disc read-only memory (CD-ROM), digital versatile disk read-only memory (DVD-ROM), digital versatile disk random-access memory (DVD-RAM), etc. Other varieties of memory devices are contemplated as well. Information handling system 100 may optionally include an auxiliary processor 108 which may be, for example, a digital signal processor (a special-purpose microprocessor having an architecture suitable for fast execution of signal processing algorithms), a back-end processor (a slave processor subordinate to the main processing system), an additional microprocessor or controller for dual or multiple processor systems, or a coprocessor.

Information handling system 100 further includes a display system 112 for connecting to a display device 114, and an input/output (I/O) system 116 for connecting to one or more I/O devices 118, 120 up to N number of I/O devices 122. Display system 112 may comprise a video display adapter having all of the components for driving the display device, including video random access memory (VRAM), buffer, and graphics engine as desired. Display device 114 may comprise a cathode ray-tube (CRT) type display such as a monitor or television, or may comprise an alternative type of display technology such as a liquid-crystal display (LCD), a light-emitting diode (LED) display, or a gas or plasma display. Input/output system 116 may comprise one or more controllers or adapters for providing interface functions between one or more of I/O devices 118-122. For example, input/output system 116 may comprise a serial port, parallel port, infrared port, network adapter, printer adapter, radio-frequency (RF) communications adapter, universal asynchronous receiver-transmitter (UART) port, etc., for interfacing between corresponding I/O devices such as a mouse, joystick, trackball, trackpad, trackstick, infrared transducers, printer, modem, RF modem, bar code reader, charge-coupled device (CCD) reader, scanner, compact disc (CD), compact disc read-only memory (CD-ROM), digital versatile disc (DVD), video capture device, touch screen, stylus, electroacoustic transducer, microphone, speaker, etc. Input/output system 116 and I/O devices 118-122 may provide or receive analog or digital signals for communication between information handling system 100 of the present invention and external devices, networks, or information sources. Input/output system 116 and I/O devices 118-122 preferably implement industry promulgated architecture standards, including USB, Fire Wire 1394, IEEE 1394 Serial Bus, Recommended Standard 232 (RS-232) promulgated by the Electrical Industries Association, Infrared Data Association (IrDA) standards, Ethernet IEEE 802 standards (e.g., IEEE 802.3 for broadband and baseband networks, IEEE 802.3z for Gigabit Ethernet, IEEE 802.4 for token passing bus networks, IEEE 802.5 for token ring networks, IEEE 802.6 for metropolitan area networks, 802.11 for wireless networks, and so on), Fibre Channel, digital subscriber line (DSL), asymmetric digital subscriber line (ASDL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on. It should be appreciated that modification or reconfiguration of information handling system 100 of FIG. 1 by one having ordinary skill in the art would not depart from the scope or the spirit of the present invention.

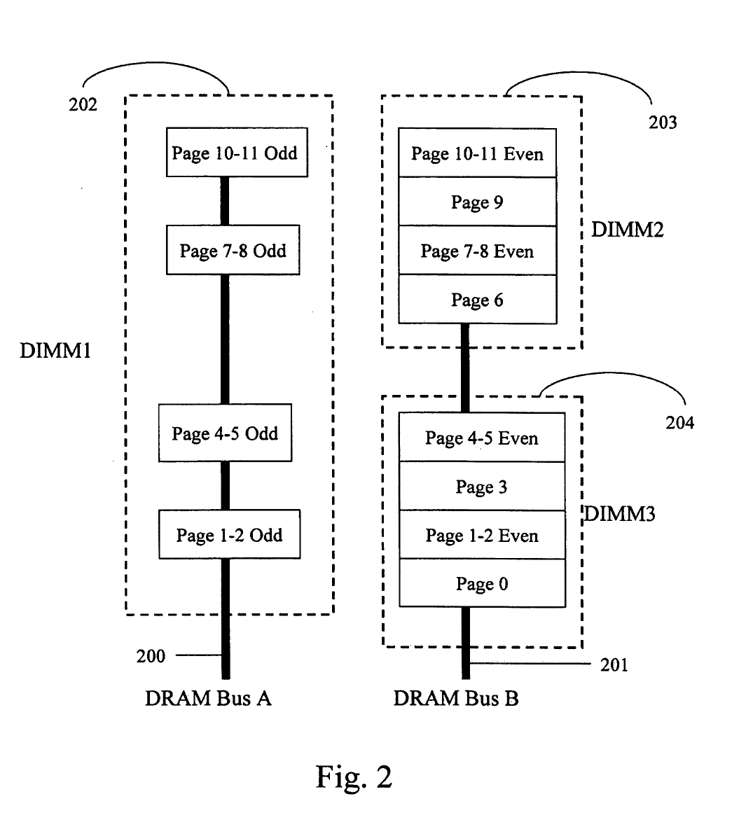

Now, referring to FIG. 2, a conceptual block diagram of the main memory 104 of the information handling system 100 is shown to present an illustrative application of the present invention. More specifically, FIG. 2 presents an illustrative example of a main memory configuration comprising two DRAM busses (A and B) for interconnecting the main memory 104 to the rest of the information handling system 100, and more particularly, the central processor 102 and the auxiliary memory 106.

For purposes of this illustrative example only, one Dual In-line Memory Module (DIMM) 202 is connected to DRAM Bus A 200 while two DIMMs 203, 204 are connected to DRAM Bus B 201. As will be readily apparent to those skilled in the art, any number of memory devices and any number of busses can be successfully employed without departing from the scope of the present invention. Additionally, SRAM or other memory technologies may also be used.

The system, either as a hardware implementation, a program of instructions, or a combination of the two, determines the quantity of memory devices present in the information handling system 100 to be interleaved. This may be performed as a first step. In the example depicted in FIG. 2, three memory devices (202, 203, and 204) are present.

Once the number of memory devices is known, the system groups the quantity of memory devices present into at least one paired set and an unpaired device, if an odd number of memory devices is present. In the case of the illustrative example, a paired set 203, 204 and an unpaired device 202 is formed. The paired set of memory devices 203,204 is then interleaved to form an initially interleaved set. The interleaving technique used for this initial interleaving may be selected from any number of conventional interleaving techniques. Illustrative examples include sequential, multi-cache line interleaving (MCI), cache effect interleaving (CEI) and DRAM Page interleaving (DPI) among others. U.S. Pat. No. 5,341,486 to Castle, U.S. Pat. No. 6,233,662 to Prince, Jr., and U.S. Pat. No. 6,381,668 to Lunteren are hereby incorporated by reference (to the extent that they are not inconsistent with the disclosure of the present invention) as illustrations of some suitable interleaving techniques, although others may also be suitable. In the example depicted in FIG. 2, DPI is used as an illustrative example.

Significantly, a subsequent interleaving is then performed with the unpaired device 202 and the initially interleaved set 203,204 to form a finally interleaved set. This subsequent interleaving of the unpaired device 202 with the initially interleaved set 203,204 may use the same interleaving technique as was used in the initial interleaving, as shown in FIG. 2. Optionally, the system may employ an interleaving technique for the subsequent interleaving that is different from the technique used for the initial interleaving.

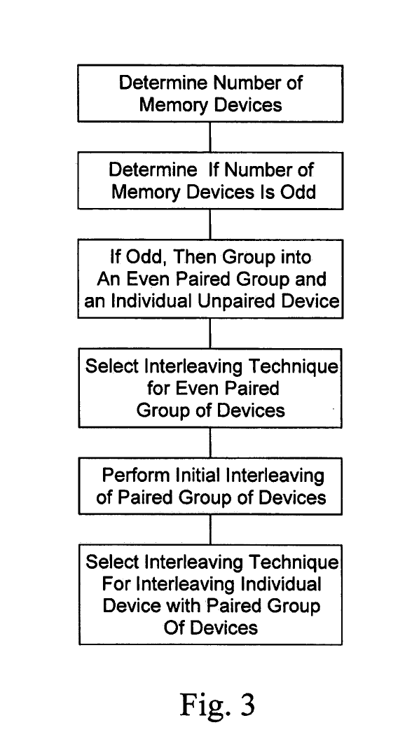

Turning to FIG. 3, a method of interleaving a memory array is depicted. The method works with an even number of devices, regardless of whether or not the number of memory devices present in the system is a power of two. However, the system also accommodates an odd number of devices and interleaves all of the memory devices present using a selected method of interleaving.

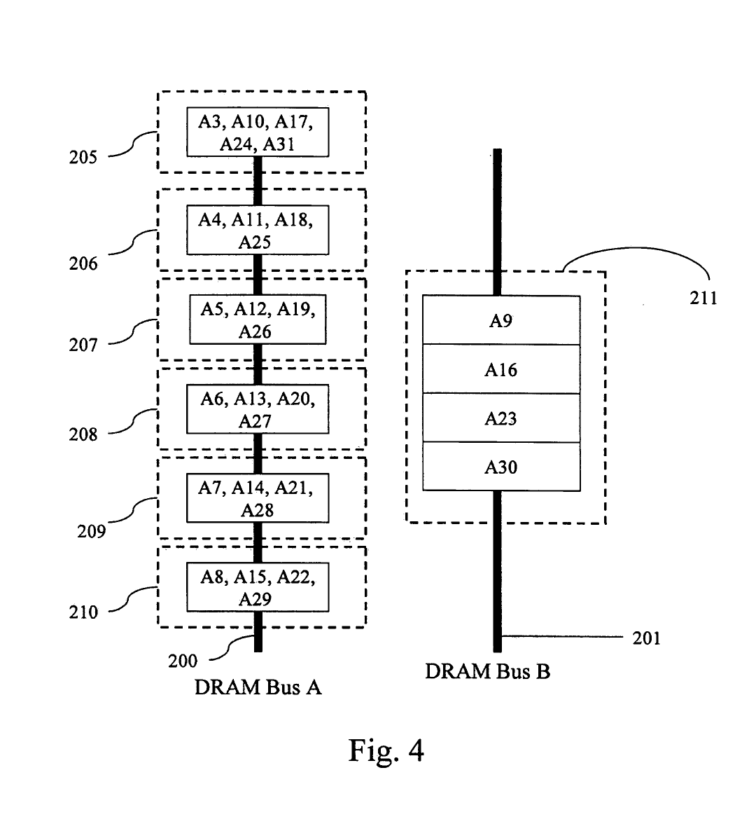

In the illustrative example depicted in FIG. 2, three memory devices were present in the system and were handled or represented as a pair of devices 203 and 204 and a single device 202. The pair of devices 203, 204 presented a number of memory devices that corresponded to a power of two. FIG. 4 depicts a further illustrative example in which the number of paired devices is not a power of two. In this further illustrative example, a total of seven memory devices are present in the system, and are handled or represented as a paired set of devices on DRAM Bus A 200 and a single unpaired memory device on DRAM Bus B 201. The six paired devices 205-210 are initially interleaved using a suitable technique. This initially interleaved set of six memory devices 205-210 could then be subsequently or finally interleaved with the single memory device 211. For example, if thirty-two bus lines (A0-A31) were tied to the address pins of the memory devices and lines A0-A2 were used by the decoder (representing the seven memory devices), then the interleaving presented by the following table could be utilized.

TABLE 1
Illustrative Seven Memory Device Interleaving

| | Memory |
|---|---|
| Address | Device |
| A3 | 205 |
| A4 | 206 |
| A5 | 207 |
| A6 | 208 |
| A7 | 209 |
| A8 | 210 |
| A9 | 211 |
| A10 | 205 |
| A11 | 206 |
| A12 | 207 |
| A13 | 208 |
| A14 | 209 |
| A15 | 210 |
| A16 | 211 |
| Etc. | Etc. |

While this further illustrative example of an interleaving scheme may not be an optimal arrangement of interleaving, those skilled in the art will readily appreciate the potential memory management advantages for handling an odd number of devices as well as an array of asymmetrically sized devices on different memory busses.

In an embodiment where the invention is implemented using software, the software may be stored in a computer program product and loaded into information handling system 100 using a form of Auxiliary memory 106 including but not limited to magnetic tape, drum, floppy disk, hard disk, optical, laser disk, compact disc read-only memory (CD-ROM), digital versatile disk read-only memory (DVD-ROM), digital versatile disk random-access memory (DVD-RAM), etc The software, when executed by the processor 102, causes the processor 102 to perform the features and functions of the invention as described herein.

In another embodiment, the invention is implemented primarily in hardware using, for example, hardware components such as application specific integrated circuits (“ASICs”). Implementation of the hardware state machine so as to perform the functions described herein will be apparent to persons having ordinary skill in the relevant art.

In yet another embodiment, the invention is implemented using a combination of both hardware and software. It is understood that modification or reconfiguration of the information handling system 100 by one having ordinary skill in the relevant art does not depart form the scope or the spirit of the present invention.

With respect to the above description then, it is to be realized that the relationships for the parts of the invention, to include variations in materials, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method of interleaving multiple memory devices comprising:
grouping a quantity of memory devices into a paired set and one unpaired device if the quantity of memory devices present is an odd number;
interleaving the paired set of memory devices to form an initially interleaved set; and
interleaving the unpaired device with the initially interleaved set to form a finally interleaved set of memory devices if the quantity of memory devices present is an odd number.

2. The method of claim 1, wherein said step of interleaving the paired set of memory devices further includes:
determining if the quantity of memory devices included in the paired set of memory devices is a power of two;
selecting an interleaving technique based at least in part upon the quantity of memory devices is a power of two.

3. The method of claim 2, wherein said step of interleaving the unpaired device with the initially interleaved set further includes selecting the same interleaving technique used to interleave the paired set.

4. The method of claim 2, wherein said step of interleaving the unpaired device with the initially interleaved set further includes selecting a different interleaving technique than used to interleave the paired set.

5. The method of claim 1, wherein said step of interleaving the unpaired device with the initially interleaved set further comprises interleaving the unpaired device with the initially interleaved set at the page level.

6. A method of interleaving multiple memory devices in a system having an odd number of memory devices comprising:
determining a quantity of memory devices present to be interleaved;
grouping the quantity of memory devices into a paired set and one unpaired device;
determining if the number of memory device included in the paired set of memory devices is a power of two;
selecting an interleaving technique based at least in part upon whether the number of memory devices is a power of two;
interleaving the paired set of memory devices to form an initially interleaved set using the selected technique;
selecting a technique to interleave the unpaired device with the initially interleaved set;
interleaving the unpaired device with the initially interleaved set to form a finally interleaved set of memory devices.

7. The method of claim 6, wherein said step of interleaving the unpaired device with the initially interleaved set further comprises interleaving the unpaired device with the initially interleaved set at the page level.

8. The method of claim 6, wherein said step of interleaving the unpaired device with the initially interleaved set further includes selecting the same interleaving technique used to interleave the paired set.

9. The method of claim 6, wherein said step of interleaving the unpaired device with the initially interleaved set further includes selecting a different interleaving technique than used to interleave the paired set.

10. A program of instructions storable on a medium readable by an information handling system for causing the information handling system to execute steps for interleaving multiple memory devices, the steps comprising:
determining a quantity of memory devices present to be interleaved;
grouping the quantity of memory devices into a paired set and one unpaired device if the quantity of memory devices present is an odd number;
interleaving the paired set of memory devices to form an initially interleaved set; and
interleaving the unpaired device with the initially interleaved set to form a finally interleaved set of memory devices if the quantity of memory devices present is an odd number.

11. The program of instructions storable on a medium readable by an information handling system of claim 10, wherein said step of interleaving the paired set of memory devices further includes:
determining if a number of memory devices included in the paired set of memory devices is a power of two;
selecting an interleaving technique based at least in part upon the number of memory devices either being a power of two or not being a power of two.

12. The program of instructions storable on a medium readable by an information handling system of claim 11, wherein said step of interleaving the unpaired device with the initially interleaved set further includes selecting the same interleaving technique used to interleave the paired set.

13. The program of instructions storable on a medium readable by an information handling system of claim 11, wherein said step of interleaving the unpaired device with the initially interleaved set further includes selecting a different interleaving technique than used to interleave the paired set.

14. The program of instructions storable on a medium readable by an information handling system of claim 10, wherein said step of interleaving the unpaired device with the initially interleaved set further comprises interleaving the unpaired device with the initially interleaved set at the page level.
